(19) United States
(12) Patent Application Publication
(10) Pub. No.: US 2026/0088371 A1
(43) Pub. Date: Mar. 26, 2026

(54) TRACTION BATTERY FOR A MOTOR VEHICLE, METHOD FOR PRODUCING A TRACTION BATTERY AND METHOD FOR OPERATING A TRACTION BATTERY

(71) Applicant: AUDI AG, lngolstadt (DE)

(72) Inventor: Simon STOLL, Manching (DE)

(73) Assignee: AUDI AG, lngolstadt (DE)

(21) Appl. No.: 19/317,431

(22) Filed: Sep. 3, 2025

(30) Foreign Application Priority Data
Sep. 20, 2024 (DE) 102024127179.5

(51) Int. Cl. H01M 10/42; H01M 10/48; H01M 50/519

(52) U.S. Cl. CPC H01M 10/425; H01M 10/48; H01M 50/519; H01M 2010/4271; H01M 2220/20

(57) ABSTRACT

A traction battery for a motor vehicle, with a battery housing in which a battery cell is arranged, which is electrically connected via an electrical connection device to an electrical battery connection of the traction battery and/or to a further battery cell also arranged in the battery housing. A gas sensor for detecting at least one gas component of a gas present in the battery housing is arranged on the connection device and is electrically connected via the connection device to a battery control device.

### FIELD

The invention relates to a traction battery for a motor vehicle, comprising a battery housing in which a battery cell is arranged, which is electrically connected via an electrical connection device to an electrical battery connection of the traction battery and/or to a further battery cell also arranged in the battery housing. The invention further relates to a method for producing a traction battery for a motor vehicle and to a method for operating a traction battery for a motor vehicle.

### BACKGROUND

In the prior art document DE 10 2020 213 990 A1 is known, for example. This describes an electrical energy storage comprising at least one electrical energy storage cell, a circuit board and a gas sensor, wherein each electrical energy storage cell has a respective degassing opening. It is provided that the gas sensor is arranged between a respective degassing opening and the circuit board.

Furthermore, document DE 10 2022 204 463 A1 discloses a battery monitoring sensor for monitoring the condition of a battery, comprising a sensor housing with a housing interior, a circuit board arranged in the housing interior with a pressure sensor module arranged on the circuit board, a gas inlet channel formed on the housing for a gas mixture released by the battery, wherein the gas inlet channel has an inlet opening for connection to the battery and wherein an end of the gas inlet channel facing away from the inlet opening opens into a first sub-space of the housing interior, wherein the first sub-space is separated from a second sub-space of the housing interior by the circuit board, wherein a first surface region of the circuit board provided with the pressure sensor module faces the first sub-space and the pressure sensor module is arranged in the first sub-space. It is provided that, in addition to the pressure sensor module, at least one further sensor module for detecting a gas component contained in the gas mixture is arranged on the first surface region of the circuit board provided with the pressure sensor module in the first subspace.

In addition, document DE 10 2022 209 233 A1 describes a battery monitoring device for monitoring the condition of a battery.

### SUMMARY

The object of the invention is to propose a traction battery for a motor vehicle which has advantages over known traction batteries, in particular can be produced cost-effectively and enables extensive monitoring, in particular for thermal runaway of the battery cell of the traction battery.

This is achieved according to the invention with a traction battery for a motor vehicle. It is provided that a gas sensor for detecting at least one gas component of a gas present in the battery housing is arranged on the connection device and is electrically connected to a battery control device via the connection device.

It is pointed out that the exemplary embodiments explained in the description are not limiting; rather, any variations of the features disclosed in the description, the claims and the figures can be implemented.

The traction battery is preferably part of the motor vehicle, but can of course also be present separately from it, in particular before the traction battery is mounted on or in the motor vehicle. The traction battery is provided and designed for the temporary storage of electrical energy for a drive device of the motor vehicle. The drive device is used to drive the motor vehicle and thus to provide a drive torque that is provided for driving the motor vehicle. To provide the drive torque, the drive device has at least one drive unit which is designed as an electric traction machine which is electrically connected to the traction battery.

The traction battery has the battery cell, preferably multiple battery cells. The battery cell or battery cells is or are preferably prismatic cells or pouch cells. If in this description the battery cell is mentioned, the statements can always be transferred to each of the battery cells. Conversely, explanations for the multiple battery cells are analogously applicable to the battery cell. Whenever the term battery cell is mentioned in this description, this always refers to at least one battery cell, i.e. exactly one battery cell or multiple battery cells.

The battery cell is electrically connected to the electrical battery connection of the traction battery. During normal operation of the traction battery, the battery cell is at least temporarily electrically connected to an on-board electrical system of the motor vehicle, in particular to the drive system of the motor vehicle, via the electrical battery connection. The electrical battery connection is located, for example, on the battery housing of the traction battery, in which the battery cell is located. In the case of a plurality of battery cells, each of the battery cells is preferably electrically connected to the battery connection and/or at least temporarily electrically connected thereto.

The battery cell is connected to the battery connection and/or to the other battery cell by means of the electrical connection device. The electrical connection device connects insofar the battery cell either to the battery connection, to the other battery cell or to both, preferably permanently. The electrical connection device can in principle be designed in any way, for example it is in the form of a circuit board, particularly preferably in the form of a flexible circuit board. For example, the connection device is arranged between the battery cell and a housing cover of the battery housing, so that when the traction battery is arranged as intended, the connection device is arranged above the battery cell and below the housing cover. Alternatively, the connection device is arranged next to the battery cell, i.e. in particular between the battery cell and a side wall of the battery housing.

The traction battery has a gas sensor, by means of which the gas present in the battery housing is checked for the presence of at least one gas component. For this purpose, the gas sensor is arranged in the battery housing so that it is in direct contact with the gas or is surrounded by the gas. The gas is basically any gas, for example the gas consists essentially or entirely of air, in particular ambient air. However, it can also be provided that the battery housing is specifically filled with a certain gas.

During operation of the traction battery, the composition of the gas may change due to chemical reactions in the battery cell. This is the case, for example, due to aging processes and in particular in the case of thermal runaway of the battery cell, during which reaction products of the thermal runaway enter the battery casing and subsequently form a component of the gas. Based on the composition of the gas, conclusions can be drawn about the condition of the battery cell and consequently the entire traction battery. The gas component is, for example, hydrogen, preferably molecular hydrogen, carbon oxide, in particular carbon monoxide and/or carbon dioxide, ammonia or the like.

The gas sensor has a sensitivity for the at least one gas component. The gas sensor can be provided and designed to detect exactly one gas component or to detect several gas components. Where this description refers to the gas component or the at least one gas component, the definitions are equivalent. Explanations relating to the at least one gas component are therefore transferable to the gas component and statements relating to the gas component are transferable to the at least one gas component. In the case of several gas components, the explanations regarding the gas component and the at least one gas component are preferably transferable to each of the several gas components.

The gas sensor is electrically connected to the battery control device. For example, the gas sensor is supplied with electrical energy by the battery control device and/or the gas sensor reports a sensor signal to the battery control device for evaluation via the electrical connection. Until now, it was necessary to connect the gas sensor to the battery control device using a separate connection cable. This makes it necessary to arrange the connection cable in addition to the other components in the battery housing and to electrically connect it to the gas sensor on the one hand and to the battery control device on the other. This requires installation space and requires corresponding working steps in the manufacture of the traction battery.

For this reason, it is provided according to the invention that the gas sensor is arranged on the connection device, in particular is fastened to the connection device. In addition, the gas sensor is electrically connected to the battery control device via the connection device. This means that no additional connection cable is provided for the gas sensor, but that it is connected to the battery control device via the same element through which the battery cell is electrically connected to the battery connection and/or the other battery cell, namely via the connection device.

Preferably, during the production of the traction battery, the connection device and the gas sensor are already provided as an assembly, wherein, for example, the gas sensor is fastened to the connection device and in particular is electrically connected to it. The assembly is inserted into the battery housing in such a way that the connection device is subsequently electrically connected to the battery cell. With the help of such a design of the traction battery or such a procedure, no additional wiring is necessary for the electrical connection of the gas sensor to the battery control device. In addition, the installation of the traction battery is simplified.

A further development of the invention provides that the gas sensor is an electromechanical sensor, in particular a microelectromechanical sensor. In the latter case, the gas sensor is thus a MEMS sensor or is in the form of a microsystem. In particular, the gas sensor is a gravimetric sensor that has a movably mounted element the movements of which are detected and evaluated by the gas sensor. The gravimetric sensor detects changes in a gravitational field, in particular the Earth's gravitational field, caused by local changes in the density of the gas.

If the gas sensor is designed as a microelectromechanical sensor, the movably mounted element is small. For example, in the direction of its greatest extent, it has dimensions of at most 100 μm, at most 10 μm or at most 1 μm. The gas sensor may comprise one or more such elements. The use of the electromechanical sensor, in particular the microelectromechanical sensor, enables particularly high measurement accuracy and also a compact and space-saving arrangement in the battery housing.

A further development of the invention provides that the gas sensor has an ultrasonic transducer with an oscillating element, wherein the ultrasonic transducer is provided and designed to set the oscillating element into an oscillating movement and to evaluate a change in the oscillating movement caused by the at least one gas component. The ultrasonic transducer has the oscillating element and sets it into oscillating motion, which is characterized by a specific oscillation frequency. The gas sensor or ultrasonic transducer are designed in such a way that the oscillating element is in fluidic connection with an interior of the battery housing, so that the oscillating element is surrounded by the gas or is flowed against by the gas.

The gas therefore causes a change in the oscillating movement, which depends in particular on its composition, for example the presence of the gas component and/or its concentration in the gas. The gas sensor detects a change caused by the gas or gas component and evaluates it. Based on the change, the gas sensor determines the presence of the gas component and/or its concentration. With such a design of the gas sensor, a particularly high level of accuracy is achieved in detecting the gas component.

A further development of the invention provides that the gas sensor has at least one further oscillating element in addition to the oscillating element, so that multiple oscillating elements are present which have different masses and/or are provided and designed for excitation with different oscillation frequencies. The gas sensor therefore does not have just a single oscillating element, but rather multiple oscillating elements, with the already mentioned oscillating element representing a part of these several oscillating elements. The oscillating elements are each set into an oscillating motion. Again, it is intended to evaluate the change in the oscillating motion caused by the gas component and to use the change to determine the presence of the gas component and/or its concentration.

Particularly preferably, the oscillating elements have different masses and/or are excited with different oscillation frequencies. The masses and the oscillation frequencies are selected in such a way that either different concentrations of the gas component are detected and/or several different gas components are detected. In particular, the gas sensor is designed to detect a plurality of gas components, in particular to determine a respective concentration of the plurality of gas components in the gas. At least one of the oscillating elements is thus designed, for example, to detect a first gas component and at least a second of the oscillating elements is designed to detect a second gas component of the gas. With very little space required, the described gas sensor can detect several different gas components.

A further development of the invention provides that the gas sensor has a sensor control device which is electrically connected to the battery control device via a data transmission connection. The detection of the gas component or the determination of its concentration is carried out by the gas sensor itself, namely with the help of the sensor control device. The sensor control device transmits data concerning the presence of the gas component and/or its concentration to the battery control device, namely via the data transmission connection. The data transmission connection is preferably a continuously conductive connection, which in turn runs through the electrical connection device. With such a design of the traction battery, it is not necessary for the battery control device to evaluate the sensor data from the gas sensor. Accordingly, the complexity of the battery control device is reduced.

A further development of the invention provides that the gas sensor has, in addition to the ultrasonic transducer, an optical sensor, in particular an infrared sensor and/or a reflection sensor. The optical sensor is intended and designed to determine at least one state variable of the gas. The state variable is, for example, also the presence of the gas component and/or the concentration of the gas component. The optical sensor works with light, especially infrared light, visible light or ultraviolet light. For example, the optical sensor is an infrared sensor, meaning it works with infrared light.

The sensor can be designed as a reflection sensor, i.e. it can have a transmitter, a receiver and a reflector. The transmitter emits light towards the reflector, from which the light is reflected and redirected to the receiver. The state variable is determined based on the light received by the receiver. For example, it is provided to determine the presence of the gas component or the concentration of the gas component using both the ultrasonic transducer and the optical sensor. An output signal of the gas sensor is therefore determined from a signal from the ultrasonic transducer and a signal from the optical sensor. This ensures particularly high accuracy of the gas sensor.

A further development of the invention provides that the connection device is designed as a flexible circuit board, wherein at least one connection conductor track for electrically connecting the battery cell to the battery connection and/or the further battery cell and a sensor conductor track for electrically connecting the gas sensor to the control device are arranged on the circuit board. The flexible circuit board has a flexible base body. For example, the base body is made of a plastic, in particular polyimide or polyester. In any case, the material of the base body is not electrically conductive. Multiple conductor tracks are applied to the base body, namely at least one connection conductor track and the sensor conductor track. The conductor tracks consist of an electrically conductive material, for example metal, which is applied to the base body. The use of the flexible circuit board enables particularly space-saving contacting of both the battery cell and the gas sensor.

The invention further relates to a method for producing a traction battery for a motor vehicle, in particular a traction battery according to the explanations in the context of this description, wherein the traction battery has a battery housing in which a battery cell is arranged, which is electrically connected via an electrical connection device to an electrical battery connection of the traction battery and/or to a further battery cell likewise arranged in the battery housing. It is provided in particular that a gas sensor for detecting at least one gas component of a gas present in the battery housing is arranged on the connection device and is electrically connected to a battery control device via the connection device.

The advantages of such procedure or embodiment of the traction battery have already been discussed above. Both the traction battery and the method for its production can be refined according to the explanations in this description, to which reference will therefore be made.

A further development of the invention provides that the gas sensor is soldered to a sensor conductor track of the connection device. The gas sensor is preferably designed here as an SMD component. An SMD component is a surface-mounted component (SMD: Surface Mounted Device). The SMD component is therefore placed on a surface, in particular on the sensor conductor track of the connection device. The design of the gas sensor as an SMD component and its soldering to the sensor conductor track enables simple and cost-effective production of the traction battery and, in particular, attachment of the gas sensor to the connection device with little effort.

The invention further relates to a method for operating a traction battery for a motor vehicle, in particular a traction battery according to the explanations in this description, wherein the traction battery has a battery housing in which a battery cell is arranged, which is electrically connected via an electrical connection device to an electrical battery connection of the traction battery and/or to a further battery cell likewise arranged in the battery housing. It is provided that a gas sensor arranged on the connection device and electrically connected to a battery control device via the connection device is operated for detecting at least one gas component of a gas present in the battery housing.

With regard to the advantages and possible advantageous developments of the traction battery and the method for its operation, reference is again made to the explanations in this description.

A further development of the invention provides that the gas sensor has at least one ultrasonic transducer with an oscillating element, wherein the oscillating element is set into an oscillating movement with a specific oscillation frequency, a change in the oscillating movement is determined and a concentration of the at least one gas component is determined from the change. Such a procedure has already been mentioned. It enables a particularly precise determination of the concentration of the gas component or its concentration.

The features and feature combinations described in the description, in particular the features and feature combinations described below in the description of the figures and/or shown in the figures may be used not only in the respective specified combination, but also in other combinations or alone, without departing from the scope of the invention, in particular within the scope of the claims. The invention should therefore also be considered to comprise embodiments that are explicitly not shown or explained in the description and/or the figures, but emerge from the explained embodiments or can be derived from them, in particular within the scope of the claims.

### BRIEF DESCRIPTION OF THE FIGURES

In the following, the invention will be explained in greater detail with reference to the exemplary embodiments depicted in the drawing, without this limiting the invention. In particular, the only

FIG. 1 shows a schematic representation of a traction battery for a motor vehicle, with a battery housing and multiple battery cells arranged in the battery housing.

### DETAILED DESCRIPTION

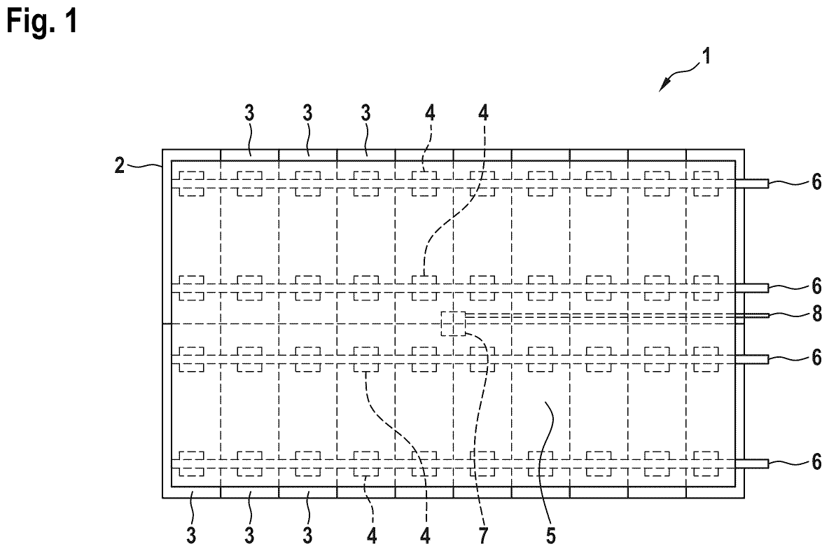

FIG. 1 is a schematic representation of a region of a traction battery 1 for a motor vehicle. The traction battery 1 has a battery housing 2 in which multiple battery cells 3 are arranged. Only a few of the battery cells 3 are marked here as examples. Each of the battery cells 3 has two connection terminals 4. Of these, only a few are provided with reference numerals as examples. The battery cells 3 or their connection terminals 4 are electrically connected to one another by an electrical connection device 5. The connection device 5 covers the battery cells 3 at least in regions. Preferably, it is in the form of a flexible circuit board on which multiple connection conductor tracks 6 are formed.

Each of the connection conductor tracks 6 connects several of the connection terminals 4 to one another. In addition, it is preferably provided that the connection conductor track 6 connects the battery cells 3 to a battery connection of the traction battery 1, not shown here. A gas sensor 7 is arranged and attached to the connection device 5. The gas sensor 7 serves to detect at least one gas component of a gas present in the battery housing 2. The connection device 5 has a sensor conductor track 8 to which the gas sensor 7 is electrically connected. The gas sensor 7 is preferably connected to a battery control device of the traction battery 1, not shown here, via the sensor conductor track 8. The described design of the traction battery 1 enables a space-saving arrangement of the gas sensor 7.

### LIST OF REFERENCE NUMERALS

1 traction battery
2 battery housing
3 battery cell
4 connection terminal
5 connection device
6 connection conductor track
7 gas sensor
8 sensor conductor track

1. A traction battery for a motor vehicle, comprising: a battery housing in which a battery cell is arranged, which is electrically connected via an electrical connection device to an electrical battery connection of the traction battery and/or to a further battery cell likewise arranged in the battery housing, wherein a gas sensor for detecting at least one gas component of a gas present in the battery housing is arranged on the connection device and is electrically connected via the connection device to a battery control device.

2. The traction battery according to claim 1, wherein the gas sensor is an electromechanical sensor.

3. The traction battery according to claim 1, wherein the gas sensor has an ultrasonic transducer with an oscillating element, wherein the ultrasonic transducer is provided and designed to set the oscillating element into an oscillating movement and to evaluate a change in the oscillating movement caused by the at least one gas component.

4. The traction battery according to claim 1, wherein the gas sensor has at least one further oscillating element in addition to the oscillating element, so that there are multiple oscillating elements which have different masses and/or are provided and designed for excitation with different oscillation frequencies.

5. The traction battery according to claim 1, wherein the gas sensor has an optical sensor in addition to the ultrasonic transducer.

6. The traction battery according to claim 1, wherein the connection device is designed as a flexible circuit board, wherein at least one connection conductor track for electrically connecting the battery cell to the battery connection and/or the further battery cell and a sensor conductor track for electrically connecting the gas sensor to the battery control device are arranged on the circuit board.

7. A method for producing a traction battery for a motor vehicle, in particular a traction battery according to claim 1, wherein the traction battery has a battery housing in which a battery cell is arranged, which is electrically connected via an electrical connection device to an electrical battery connection of the traction battery and/or to a further battery cell likewise arranged in the battery housing, wherein a gas sensor for detecting at least one gas component of a gas present in the battery housing is arranged on the connection device and is electrically connected via the connection device to a battery control device.

8. The method according to claim 7, characterized in that the gas sensor is soldered to a sensor conductor track of the connection device.

9. A method for operating a traction battery for a motor vehicle, in particular a traction battery according to claim 1, wherein the traction battery has a battery housing in which a battery cell is arranged, which is electrically connected via an electrical connection device to an electrical battery connection of the traction battery and/or to a further battery cell likewise arranged in the battery housing, wherein a gas sensor which is arranged on the connection device and is electrically connected via the connection device to a battery control device is operated for detecting at least one gas component of a gas present in the battery housing.

10. The method according to claim 9, wherein the gas sensor has at least one ultrasonic transducer with an oscillating element, wherein the oscillating element is set into oscillation at a specific oscillation frequency, a change in the oscillation is detected and a concentration of the at least one gas component is determined from the change.

11. The traction battery according to claim 2, wherein the gas sensor has an ultrasonic transducer with an oscillating element, wherein the ultrasonic transducer is provided and designed to set the oscillating element into an oscillating movement and to evaluate a change in the oscillating movement caused by the at least one gas component.

12. The traction battery according to claim 2, wherein the gas sensor has at least one further oscillating element in addition to the oscillating element, so that there are multiple oscillating elements which have different masses and/or are provided and designed for excitation with different oscillation frequencies.

13. The traction battery according to claim 3, wherein the gas sensor has at least one further oscillating element in addition to the oscillating element, so that there are multiple oscillating elements which have different masses and/or are provided and designed for excitation with different oscillation frequencies.

14. The traction battery according to claim 2, wherein the gas sensor has an optical sensor in addition to the ultrasonic transducer.

15. The traction battery according to claim 3, wherein the gas sensor has an optical sensor in addition to the ultrasonic transducer.

16. The traction battery according to claim 4, wherein the gas sensor has an optical sensor in addition to the ultrasonic transducer.

17. The traction battery according to claim 2, wherein the connection device is designed as a flexible circuit board, wherein at least one connection conductor track for electrically connecting the battery cell to the battery connection and/or the further battery cell and a sensor conductor track for electrically connecting the gas sensor to the battery control device are arranged on the circuit board.

18. The traction battery according to claim 3, wherein the connection device is designed as a flexible circuit board, wherein at least one connection conductor track for electrically connecting the battery cell to the battery connection and/or the further battery cell and a sensor conductor track for electrically connecting the gas sensor to the battery control device are arranged on the circuit board.

19. The traction battery according to claim 4, wherein the connection device is designed as a flexible circuit board, wherein at least one connection conductor track for electrically connecting the battery cell to the battery connection and/or the further battery cell and a sensor conductor track for electrically connecting the gas sensor to the battery control device are arranged on the circuit board.

20. The traction battery according to claim 5, wherein the connection device is designed as a flexible circuit board, wherein at least one connection conductor track for electrically connecting the battery cell to the battery connection and/or the further battery cell and a sensor conductor track for electrically connecting the gas sensor to the battery control device are arranged on the circuit board.
